(19) United States
(12) Patent Application Publication
(10) Pub. No.: US 2025/0219408 A1
(43) Pub. Date: Jul. 3, 2025

(54) ELECTRICAL GRID PROTECTION USING GRID COMPONENTS

(71) Applicant: X Development LLC, Mountain View, CA (US)

(72) Inventors: Sze Mei Cat Wong, Johns Creek, GA (US); Laura Elizabeth Fedoruk, Burlingame, CA (US); Leo Francis Casey, San Francisco, CA (US); Hamed Khalilinia, San Mateo, CA (US)

(21) Appl. No.: 19/002,545

(22) Filed: Dec. 26, 2024

Related U.S. Application Data
(60) Provisional application No. 63/615,616, filed on Dec. 28, 2023.

(51) Int. Cl. H02J 3/00; H02J 3/38

(52) U.S. Cl. CPC H02J 3/0012; H02J 3/381; H02J 2203/10; H02J 2203/20; H02J 2300/24

(57) ABSTRACT

Methods, systems, and apparatus, including computer programs encoded on a storage device, for protecting an electrical grid are disclosed. A method includes obtaining electrical grid data corresponding to grid reliability factors and grid safety factors; determining, based on an analysis of the grid reliability factors and the grid safety factors, one or more operating parameters for at least one electrical protection device; and controlling the at least one electrical protection device based on the one or more operating parameters.

### RELATED APPLICATION

This application claims priority under 35 U.S.C. § 119(e) to U.S. Provisional Application Ser. No. 63/615,616, filed on Dec. 28, 2023, the disclosures of which are incorporated herein by reference in their entirety.

### BACKGROUND

Protection schemes for electrical grids define the behavior of components when addressing faults or disturbances in the operation of the electrical grids. Many electrical grids contain components such as reclosers to address faults and put the grid back in its normal operating condition, or inverters to convert DC into AC electricity or AC into DC electricity. In a conventional protection scheme, components such as reclosers and inverters may have fixed behaviors, such as predefined parameters, that may not be ideal for safety or reliability based on the dynamic conditions of the electrical grid and the geographic area.

### SUMMARY

This specification relates generally to electrical grid protection systems.

In general, the specification relates to a dynamic protection control system for electrical grids. This specification describes implementations to provide the advantage of dynamically adjusting the behavior of components, in order to balance safety and reliability considerations according to the dynamic conditions of the electrical grid and the geographic area. Conditions can include the number of customers, type of customers, type of electricity source such as a renewable source, time of day, wind speed, weather, humidity, vegetation, fire risks, loading, criticality of loads, the ease of getting to a fault location, how rerouting can occur, type of fault, etc. The dynamic protection control system can evaluate such conditions and adjust the behavior of components in the electrical grid to balance safety and reliability.

This is advantageous in that the protection control system of the electrical grid balances reliability and safety, and dynamically tailors the behavior of components in the electrical grid in response. The specification presents two techniques for adjusting the behavior of components in the electrical grid: (1) adjusting the behavior of protective schemes with reclosers, and (2) adjusting the behavior of inverters.

After a fault such as an object coming into contact with a power line, a protective relay can re-establish the operation of the power line by sending a signal to a recloser or circuit breaker to perform a reclosing operation. However, it may take multiple reclosings to address a fault, and each reclosing runs the risk of creating an arc that can cause fires. Thus, for example, by dynamically changing the reclosing behavior of reclosers in protective schemes based on the dynamic conditions of the electrical grid and the geographic area, the control system can reduce the number of attempted reclosings when conditions are dangerous for reclosings and safety is a priority. The control system can increase the number of attempted reclosings when conditions are conducive to reclosings and reliability is a priority.

Inverters convert DC into AC electricity or AC into DC electricity. Inverters are predominantly used in conjunction with electricity sources such as solar energy, DC wind generators, and power storage (e.g., batteries). A solar power inverter may typically shut down (or shift to a standby/power saving state) at night while solar power is not being generated. However, inverters can have a high capacity to absorb current, and, if activated, can quickly change the direction of their operation to absorb excess current from a fault. Similarly, an inverter supplying power to/from a battery can shift a mode of operation between charging or discharging a battery to respond to potential changes in power grid activity. For example, in conditions where there is likely to be extra current in the electrical grid, such as weather conditions that are conducive to lightning strikes, the control system can adjust the behavior of inverters to keep them active and use them as dynamic protection devices that absorb the extra current from lightning strikes.

In some instances, both of the foregoing techniques can be used simultaneously along with other techniques for other components of electrical grids. That is, both adjusting the reclosing behavior of reclosers in protective schemes, and using inverters to absorb extra current, can be used in the dynamic protection system in order to balance safety and reliability.

In general, innovative aspects of the subject matter described in this specification can be embodied in methods that include the actions of obtaining electrical grid data corresponding to grid reliability factors and grid safety factors relevant to at least one electrical protection device located in a particular region of an electrical grid; determining, based on an analysis of the grid reliability factors and the grid safety factors, one or more operating parameters for the at least one electrical protection device. The analysis balances the grid reliability factors against the grid safety factors for the particular region. The methods include controlling the at least one electrical protection device based on the one or more operating parameters.

Other implementations of this aspect include corresponding systems, apparatus, and computer programs, configured to perform the actions of the methods, encoded on computer storage devices.

These and other implementations can each optionally include one or more of the following features. In some implementations, the particular region includes one or more sub regions, each sub region being specific to one or more of the grid reliability factors or grid safety factors.

In some implementations, a sub region for an environmental condition is smaller than a sub region for a load criticality factor.

In some implementations, the grid safety factors include at least one of: a time of day, weather within the particular region or sub region, vegetation within the particular region or sub region, humidity within the particular region or sub region, or data indicative of a fault.

In some implementations, the grid reliability factors include at least one of: a time of day, data indicative of a fault, a load usage percentage, a type of electrical source, a number of customers, a type of customer, a geographic location, or a load criticality factor.

In some implementations, at least one electrical protection device is a recloser in a protective scheme operating at a first setpoint. The one or more operating parameters include a second setpoint. Controlling the recloser based on the one or more operating parameters includes sending instructions to the recloser to change the first setpoint to the second setpoint.

In some implementations, determining the one or more operating parameters includes: obtaining, for a recloser within the particular region, a fault setpoint; determining that a proportion of inverter-based resources within the particular region is greater than a threshold; and in response, adjusting the fault setpoint in accordance with the proportion of inverter-based resources.

In some implementations, at least one electrical protection device is a recloser in a protective scheme operating at a first mode of operation. The one or more operating parameters include a second mode of operation. Controlling the recloser based on the one or more operating parameters includes sending instructions to the recloser to change the first mode of operation to the second mode of operation.

In some implementations, at least one electrical protection device is an inverter operating at a first mode of operation. The one or more operating parameters include a second mode of operation. Controlling the inverter based on the one or more operating parameters includes sending instructions to the inverter to change the first mode of operation to the second mode of operation.

In some implementations, the method further includes: receiving data indicative of a fault in the electrical grid; and determining a fault type based on the data. Determining one or more operating parameters includes dynamically adjusting the operating parameters based on the fault type.

In some implementations, the method further includes: receiving data indicative of a fault in the electrical grid; and determining a time of fault based on the data. Determining one or more operating parameters includes dynamically adjusting the operating parameters based on the time of fault.

In some implementations, determining one or more operating parameters for the at least one electrical protection device includes: obtaining grid reliability factors and grid safety factors; assigning a value to one or more of the grid reliability factors and grid safety factors; determining a safety and reliability score by multiplying each value by a corresponding weight and combining the values; and determining operating parameters by comparing the safety and reliability score with threshold scores.

Other embodiments of these and other aspects include corresponding systems, apparatus, and computer programs, configured to perform the actions of the methods, encoded on computer storage devices. A system of one or more computers or other processing devices can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

Particular implementations of the subject matter described in this specification can be implemented so as to realize one or more of the following advantages. Implementations may provide at least the following technical advantages and/or technical improvements over previously available solutions. The techniques can be used in a protection control system for an electrical grid that balances safety and reliability, and adjust the behavior of components in the protection control system depending on electrical grid and environmental conditions. For example, when reliability of the grid is prioritized, the system can keep the electrical grid operational. Attempts to keep the electrical grid operational such as reclosings can impact safety. Thus when safety is prioritized, the system can reduce attempts to keep the electrical grid operational.

The system can obtain information corresponding to grid reliability factors and grid safety factors from monitors on the electrical grid, for example. The system can analyze the grid reliability factors and grid safety factors and determine operating parameters for a component in the protection control system that prioritize safety or reliability. The system can then control the component based on the operating parameters. Thus the system can dynamically adjust the protection control system to prioritize safety or reliability based on relevant and timely information from the real world.

Methods in accordance with the present disclosure may include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

FIG. 1 is a contextual diagram of an example system for dynamically protecting an electrical grid.

FIG. 2 is a schematic diagram of an example system for determining operating parameters for components in the electrical grid using grid reliability factors and grid safety factors.

FIG. 3 is a flowchart of an example process for dynamically protecting an electrical grid.

FIG. 4 is a flowchart of an example process for determining operating parameters for components in the electrical grid using grid reliability factors and grid safety factors.

FIG. 5 is a diagram of an example region with sub regions corresponding to grid reliability factors and grid safety factors.

FIG. 6 depicts a schematic diagram of a computer system that may be applied to any of the computer-implemented methods and other techniques described herein.

Like reference numbers and designations in the various drawings indicate like elements.

### DETAILED DESCRIPTION

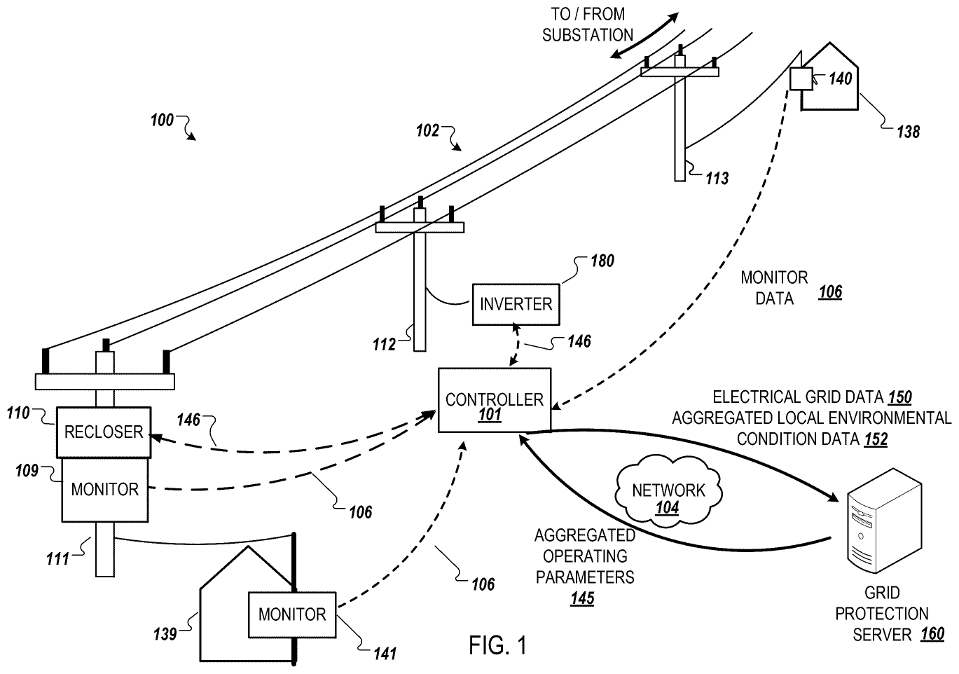

FIG. 1 is a contextual diagram of an example system 100 for dynamically protecting an electrical grid. The system 100 includes utility poles 111, 112, and 113, a controller 101, loads 138 and 139, a network 104, and a grid protection server 160.

The utility poles 111, 112, and 113 support three-phase primary distribution lines 102. The primary distribution lines 102 transport electrical power from a substation (not shown) to electrical loads. Electric generating power plants commonly produce three-phase alternating current (AC) electrical power. The three-phase power can be distributed through power lines of an electrical grid to service cables that connect to loads such as residential, commercial, and industrial properties. For example, load 138 can be a commercial property such as a hospital and load 139 can be a residential property such as a house.

The system 100 includes utility poles 111, 112, 113. Some of the utility poles can support a recloser. For example, utility pole 111 can support a protective scheme that includes a recloser 110. The protective scheme can also include other components such as a protective relay and circuit breaker. The protective relay can send signals to reclosers or circuit breakers to perform a reclosing. The protective scheme can detect faults on the distribution lines connected to the utility pole 111, and re-establish the operation of the distribution line by performing a reclosing operation. For example, a fault can occur when a lightning strike, surge, or foreign object comes into contact with a distribution line. If a protective scheme detects the occurrence of a fault, the protective scheme can trip, disabling the operation of the distribution line. The protective scheme can then use the recloser to perform a reclosing operation that re-establishes the operation of the distribution line. Although shown in FIG. 1 as supporting a single recloser, in some examples a single utility pole supports more than one recloser, e.g., two or three reclosers. Although FIG. 1 shows one utility pole supporting a recloser, in some examples more than one utility pole can support a recloser.

The protective scheme can send and receive data to and from the controller 101. The protective scheme can receive data representing operating parameters 146 from the controller 101 and operate under the received operating parameters 146. In some implementations, the protective scheme can send data representing current operating parameters 146 to the controller 101. In some implementations, the recloser 110 can send and receive data to and from the controller 101.

The utility pole 111 can support a monitor 109. The monitor 109 can be provided as one or more computer executable software modules, hardware modules, or a combination thereof. For example, the monitor 109 can be implemented as blocks of software code with instructions that cause one or more processors to execute operations described herein. In addition or alternatively, the monitor 109 can be implemented in electronic circuitry such as, e.g., programmable logic circuits, field programmable logic arrays (FPGA), or application specific integrated circuits (ASIC) that is configured to obtain monitor data 106 that characterizes the conditions within the electrical grid. Although FIG. 1 shows one utility pole supporting a monitor, in some examples more than one utility pole can support a monitor.

For example, the monitor can include a sensor such as a camera or a geographic positioning system. The monitor can also include a local environmental condition sensor that senses localized weather conditions such as humidity and temperature. Another example of a sensor that senses localized weather conditions is a lightning detector. The monitor can also include sensors that measure load data such as characteristics of power flowing to the loads connected to the monitor. For example, the sensors can measure electrical properties such as voltage, current, phase, power factor, power flow, etc. In addition, the monitor can include sensors that detect voltage or current signatures, for example, that may indicate a fault or disturbance.

The system 100 can also include monitors 140 and 141 at the loads 138 and 139. The monitors 140 and 141 can monitor electricity usage of the load. For example, the monitor 140 or 141 measures characteristics of power flowing to the hospital 138 or house 139. Data collected by the monitor can include, for example, voltage, current, power factor, and the amount of energy consumed by the property.

The monitors 109, 140, and 141 can send the monitor data 116 to the controller 101. For example, the monitors 109, 140, and 141 can send the monitor data 116 to the controller 101 upon receiving a request from the controller 101. In other examples, the monitors 109, 140, and 141 can send the monitor data 116 to the controller 101 at a regular interval. In other examples, the monitors 109, 140, and 141 can send the monitor data 116 to the controller 101 in response to an event. For example, upon detecting a lightning strike, the monitor 109 can send monitor data 116 to the controller 101.

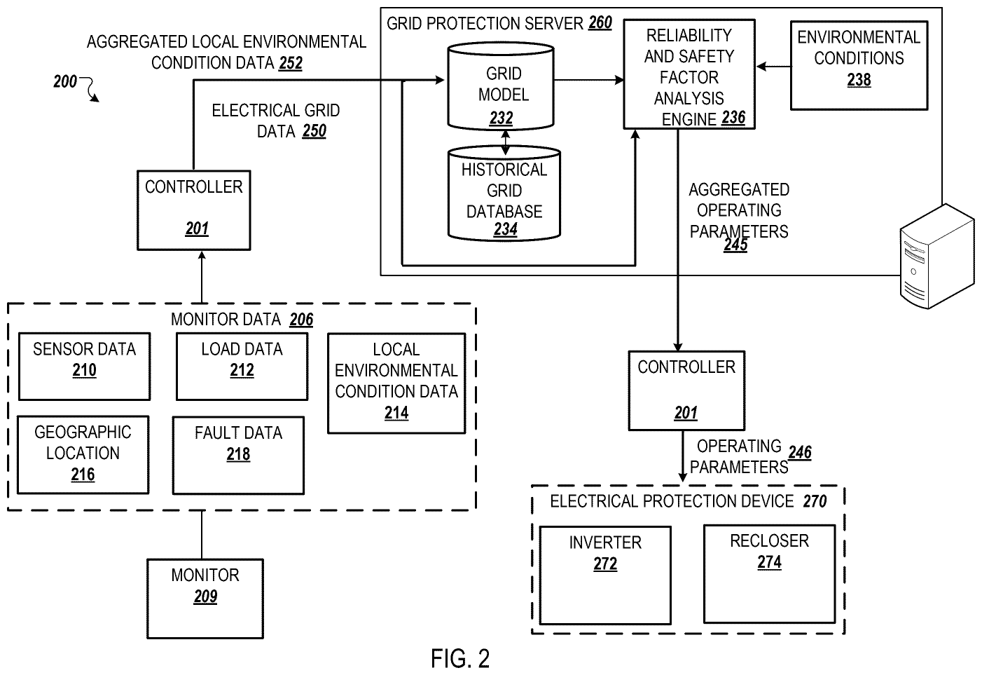

The monitor data 116 for each monitor 109, 140, and 141 can include the sensor data, load data, local environmental condition data, geographic location data, and fault data measured by the monitor. The monitor data 116 will be described in further detail below in FIG. 2.

The monitors 109, 140, and 141 can send the monitor data 116 to the controller 101 over the network 104 using a communications interface. The communications interface is a network interface, e.g., a cellular network interface, a local area network interface (e.g., Wi-Fi interface), a fiber optic interface, or another appropriate networking interface.

The system 100 can include inverters such as inverter 180. The inverter 180 converts DC into AC electricity or AC into DC electricity. For example, inverters are predominantly used in conjunction with electricity sources such as solar energy, DC wind generators, and power storage (e.g., batteries). The inverter 180 can convert electricity from electricity sources into the type of electricity used by the electrical grid, e.g., convert DC to AC electricity. The inverter 180 can be connected to the electrical grid, for example, through utility pole 112. A solar power inverter may typically shut down (or shift to a standby/power saving state) at night while solar power is not being generated. However, inverters can have a high capacity to absorb current, and, if activated, can quickly change the direction of their operation to absorb excess current from a fault. Similarly, an inverter supplying power to/from a battery can shift a mode of operation between charging or discharging a battery to respond to potential changes in power grid activity.

The inverter 180 can send and receive data to and from the controller 101. The inverter 180 can receive data representing operating parameters 146 from the controller 101 and operate under the received operating parameters 146. In some implementations, the inverter 180 can send data representing current operating parameters 146 to the controller 101.

The controller 101 can be provided as one or more computer executable software modules, hardware modules, or a combination thereof. For example, the controller 101 can be implemented as blocks of software code with instructions that cause one or more processors to execute operations described herein. In addition or alternatively, the controller 101 can be implemented in electronic circuitry such as, e.g., programmable logic circuits, field programmable logic arrays (FPGA), or application specific integrated circuits (ASIC) that is configured to receive monitor data 106, data from components such as protective schemes with reclosers and inverters, and aggregated operating parameters 145, and to send electrical grid data 150 and aggregated local environmental condition data 152. In some implementations, the controller 101 can also send data representing current operating parameters of a component such as a recloser in a protective scheme or inverter, to the grid protection server 160.

The controller 101 is configured to receive monitor data 106 from monitors 109, 140, and 141 and to send electrical grid data 150 to the grid protection server 160. The controller 101 can consolidate the monitor data 106 received from each monitor 109, 140, and 141 into electrical grid data 150. Thus, the electrical grid data 150 can include, for example, sensor data, load data, geographic location data, and fault data from monitors 109, 140, and 141. For example, the load data can include characteristics of power measured by monitor 109 (e.g., power flowing to loads connected to monitor 109) and characteristics of power measured by monitors 140 and 141 (e.g., power flowing to loads connected to monitors 140 and 141). The controller 101 can also consolidate the local environmental condition data in monitor data 106 and monitor data from other monitors into aggregated local environmental condition data 152. The controller can also send aggregated local environmental condition data 152 to the grid protection server 160.

Although shown in FIG. 1 as having a single controller 101, the system 100 can include multiple controllers such as controller 101. For example, each controller can be configured to receive monitor data 106 from, for example, monitors that are located within a certain geographic region.

Although shown in FIG. 1 as having a controller 101, the system 100 does not need to include a controller 101. For example, the monitors 109, 140 and 141 can send monitor data 106 to the grid protection server 160. The monitors 109, 140, and 141 can send monitor data 106 over the network 104 using a communications interface. The communications interface is a network interface, e.g., a cellular network interface, a local area network interface (e.g., Wi-Fi interface), a fiber optic interface, or another appropriate networking interface.

In some examples, data from the monitors can be referenced to accurate time references, e.g., a GPS time base or network time. The data from the monitors can include timestamps indicating the time when the data was collected. The controller 101 can therefore synchronize the data. For example, the controller 101 may receive monitor data 106 from monitor 109 at 10:02 am, with the data having a timestamp of 10:00 am. The controller 101 may receive monitor data 106 from monitor 119 at 10:03 am, also with the data having a timestamp of 10:00 am. The controller 101 can therefore consolidate the data from monitor 109 and monitor 119, and assign the consolidated data a timestamp of 10:00 am.

In some examples, the electrical grid data 150 can include a near real-time total electrical load of the loads connected to the monitors. For example, the electrical grid data 150 can include summed data, e.g., a sum of the power usage measured by the monitors. For example, a sum of the power usage measured by the monitors can indicate a total electricity usage of the loads connected to the monitors. In some examples, the electrical grid data 150 includes averaged data, e.g., average voltage data from the monitors. In some examples, the electrical grid data 150 includes filtered data. For example, the controller 101 can consolidate the monitor data 106 and perform filtering operations to filter out noise. In some examples, the electrical grid data 150 includes a number of monitors that provided monitor data 106. For example, the electrical grid data 150 can indicate that the electrical grid data 150 was determined using data from three monitors.

In some examples, in addition to or instead of the electrical grid data 150 and aggregated local environmental condition data 152, the controller 101 can perform calculations using the monitor data and can transmit results of the calculations to the grid protection server 160. For example, the controller 101 can use the received monitor data 106 to determine a score that indicates the risk of a lightning strike, and transmit the score in aggregated local environmental condition data 152 to the grid protection server 160. For example, the controller 101 can calculate how many lightning strikes were detected over a period of time.

The controller 101 can transmit the electrical grid data 150 and aggregated local environmental condition data 152 to the grid protection server 160 over the network 104 using a communications interface. The communications interface is a network interface, e.g., a cellular network interface, a local area network interface (e.g., Wi-Fi interface), a fiber optic interface, or another appropriate networking interface.

In some examples, the controller 101 can store some data in a memory, while transmitting other data to the grid protection server 160. The controller 101 can determine to store certain monitor data and to transmit certain monitor data, for example, based on pre-programmed settings, or based on the capabilities and usage of the network. For example, the controller 101 can store monitor data 106 in a memory, and transmit some of the monitor data 106 as electrical grid data 150 or aggregated local environmental condition data 152 to the grid protection server 160. For example, the controller 101 can store local environmental condition data such as data indicating the detection of a lightning strike, and the time of the detection. The controller 101 can thus access the stored data in order to calculate the number of lightning strikes in a past period of time. The controller 101 can transmit the number of lightning strikes in a past period of time as aggregated local environmental condition data 152 when the number of lightning strikes is over a threshold number of strikes, or at regular intervals of time, for example. In some examples, the controller 101 deletes the stored data, e.g., after receiving a confirmation signal from the grid protection server 160, after receiving an instruction from the grid protection server 160 to delete the data, or after a predetermined period of time has elapsed.

The controller 101 is also configured to receive aggregated operating parameters 145 from the grid protection server 160, and to send operating parameters 146 to grid components such as protective schemes with reclosers and inverters. The operating parameters 146 that the controller 101 sends to grid components can be a subset of the aggregated operating parameters 145 received by the controller 101. For example, the controller 101 may receive aggregated operating parameters 145 for multiple grid components such as protective schemes with reclosers. The aggregated operating parameters 145 includes a set of operating parameters for the protective scheme that includes recloser 110, and a set of operating parameters for each protective scheme with a recloser in communication with controller 101. The controller 101 is configured to send the operating parameters 146 corresponding to a particular component to that particular component. For example, the controller 101 sends the operating parameters 146 for the protective scheme that includes recloser 110 to recloser 110 or to the protective scheme that includes recloser 110.

The aggregated operating parameters 145 can include identifiers that identify which grid component each set of operating parameters corresponds to. The aggregated operating parameters 145 and operating parameters 146 can include setpoints for grid components, e.g., setpoints that reclosers operate at. The aggregated operating parameters 145 and operating parameters 146 can also include fault setpoints. The aggregated operating parameters 145 and operating parameters 146 can also include modes of operation for grid components, e.g., modes of operation for reclosers in protective schemes and inverters.

The grid protection server 160 can be a computer server or group of computer servers maintained by an electrical utility or service provider. The grid protection server 160 receives the electrical grid data 150 and aggregated local environmental condition data 152 from the controller 101. The grid protection server 160 can include a communications interface for communicating with controllers such as controller 101. In some implementations, the grid protection server 160 can receive data representing current operating parameters of components such as protective schemes with reclosers and inverters. In some implementations where the system 100 does not include a controller 101, the grid protection server 160 can receive monitor data 106 from monitors 109, 140, and 141 and data representing current operating parameters of components.

The grid protection server 160 can access stored data related to grid components such as protective schemes with reclosers, monitors, and inverters. For example, the grid protection server 160 can store, or can access from a database, data indicating a location of each recloser and a location of each monitor. In some examples, the stored data can include a unique identifier for each component. In some implementations, the grid protection server 160 can store data indicating current operating parameters of components such as protective schemes with reclosers and inverters.

For example, the grid protection server 160 can store data indicating that the monitor 109 is connected to utility pole 111. The grid protection server 160 can store a location of the monitor 109 and a location of the utility pole 111. In some examples, the stored location of a grid component such as a monitor or recloser can include a geographic coordinate location, e.g., a latitude and longitude of the location of the grid component.

The grid protection server 160 can analyze the electrical grid data 150 and aggregated local environmental condition data 152 to determine aggregated operating parameters 145. The grid protection server 160 can include a processor or other control circuitry configured to execute instructions of a program that can analyze the electrical grid data 150 and aggregated local environmental condition data 152, as well as stored data related to grid components and environmental conditions, to determine aggregated operating parameters 145. The operations of the grid protection server 160 will be discussed in further detail below with reference to FIG. 2.

The grid protection server 160 can communicate with the controller 101 over the network 104 using, for example, a long-range wired or wireless connection. The network 104 can be a long range communication network and can include the internet. The grid protection server 160 may connect via Wi-Fi, Bluetooth, or any other protocol used to communicate with the controllers, e.g., controller 101. In some implementations, the grid protection server 160 can communicate with monitors 109, 140, and 141, recloser 110, and inverter 180 over the network 104.

In some implementations, the grid protection server 160 can continuously, or near continuously, receive the electrical grid data 150 and aggregated local environmental condition data 152. In some implementations, the grid protection server 160 can receive the electrical grid data 150 and aggregated local environmental condition data 152 periodically. For example, the grid protection server 160 can receive the electrical grid data 150 and aggregated local environmental condition data 152 once per second, once per minute, once every fifteen minutes, or once per hour.

In some implementations, the grid protection server 160 can obtain the electrical grid data 150 and aggregated local environmental condition data 152 in response to an event. For example, the grid protection server 160 can obtain the electrical grid data 150 and aggregated local environmental condition data 152 in response to a loss of power to part of the electrical distribution system or detection of a fault or disturbance in the electrical grid. In some implementations, in response to a detected event, the grid protection server 160 can send instructions to the controller 101 requesting data, and in response, the controller 101 can transmit the electrical grid data 150 and aggregated local environmental condition data 152 to the grid protection server 160. As another example, the grid protection server 160 can obtain the electrical grid data and aggregated local environmental condition data 152 in response to a detected lightning strike by a monitor.

In some implementations, the grid protection server 160 can obtain the electrical grid data 150 and aggregated local environmental condition data 152 in response to a user request. For example, a user can input a request to the grid protection server 160, e.g., through a user interface, requesting updated electrical grid information. In response to the user request, the grid protection server 160 can send instructions to the controller 101 and the controller 101 can provide the electrical grid data 150 and aggregated local environmental condition data 152 to the grid protection server 160.

The grid protection server 160 can transmit the aggregated operating parameters 146 to the controller 101. The controller 101 can send the operating parameters 145 to the corresponding electrical protection device, for example, the protective scheme with recloser 110, or inverter 180. In some implementations, such as implementations where the system 100 does not include a controller 101, the grid protection server 160 can transmit operating parameters 145 to each electrical protection device.

FIG. 2 is a schematic diagram of an example system 200 for determining operating parameters for components in the electrical grid using grid reliability factors and grid safety factors. The system 200 includes a monitor 209, controller 201, grid protection server 260, and electrical protection device 270.

The monitor 209 sends monitor data 206 to the controller 201. The monitor data 206 can include, for example, sensor data 210, load data 212, local environmental condition data 214, geographic location 216, and fault data 218. Sensor data 210 can include a time of day. Sensor data 210 can also include camera data that shows the type and condition of vegetation in the area around monitor 209. Load data 212 can include data about electricity usage of loads connected to monitor 209. For example, load data 212 can include voltage, current, power factor, and amount of energy consumed by the loads connected to monitor 209. The local environmental condition data 214 can be measured by localized environmental condition sensors and can include, for example, humidity, temperature, lightning detection, and wind speed and direction at the monitor 209. The geographic location 216 can be measured by a geographic positioning system and can include a geographic coordinate location, e.g., a latitude and longitude of the monitor 209. The fault data 218 can include data indicative of a fault, such as a voltage or current signature. The fault data 218 can also include a timestamp of a potential fault. In some implementations, the monitor data 206 can also include an identifier that identifies the monitor 209.

The controller 201 receives monitor data 206 from monitor 209. The controller can also receive monitor data 206 from multiple monitors. The controller can consolidate the monitor data 206 from the monitors and generate electrical grid data 250 and aggregated local environmental condition data 252, as described above in FIG. 1. Thus, the electrical grid data 250 can include sensor data, load data, geographic location data, fault data, and/or identifier data.

The controller 201 can output electrical grid data 250 and aggregated local environmental condition data 252 to the grid protection server 260. The grid protection server 260 can receive the electrical grid data 250 and aggregated local environmental condition data 252. For example, the controller 201 can output electrical grid data 250 and aggregated local environmental condition data 252 at regular intervals of time, in response to an event such as a detected lightning strike at monitor 209, or in response to a request from the grid protection server 260.

In some implementations, the system 200 does not include a controller 201. In these implementations, the monitor 209 can output monitor data 206 to the grid protection server 260.

The grid protection server 260 can include a reliability and safety factor analysis engine 236. In some implementations, the grid protection server 260 can include a grid model 232 and a historical grid database 234. The reliability and safety factor analysis engine 236 can be provided as one or more computer executable software modules, hardware modules, or a combination thereof. For example, the reliability and safety factor analysis engine 236 can be implemented as blocks of software code with instructions that cause one or more processors of the grid protection server 260 to execute operations described herein. In addition or alternatively, the reliability and safety factor analysis engine 236 can be implemented in electronic circuitry such as, e.g., programmable logic circuits, field programmable logic arrays (FPGA), or application specific integrated circuits (ASIC) that is configured to perform an analysis of electrical grid data that balances grid reliability factors and grid safety factors. The reliability and safety factor analysis engine 236 can determine operating parameters 246 for an electrical protection device 270 based on the analysis.

The reliability and safety factor analysis engine 236 receives electrical grid data 250 and aggregated local environmental condition data 252. The reliability and safety factor analysis engine 236 applies the electrical grid data 250, aggregated local environmental condition data 252, data from grid model 232, and data from historical grid database 234 to grid safety factors such as a time of day, weather, vegetation, humidity, or data indicative of a fault, and grid reliability factors such as a time of day, data indicative of a fault, or a geographic location.

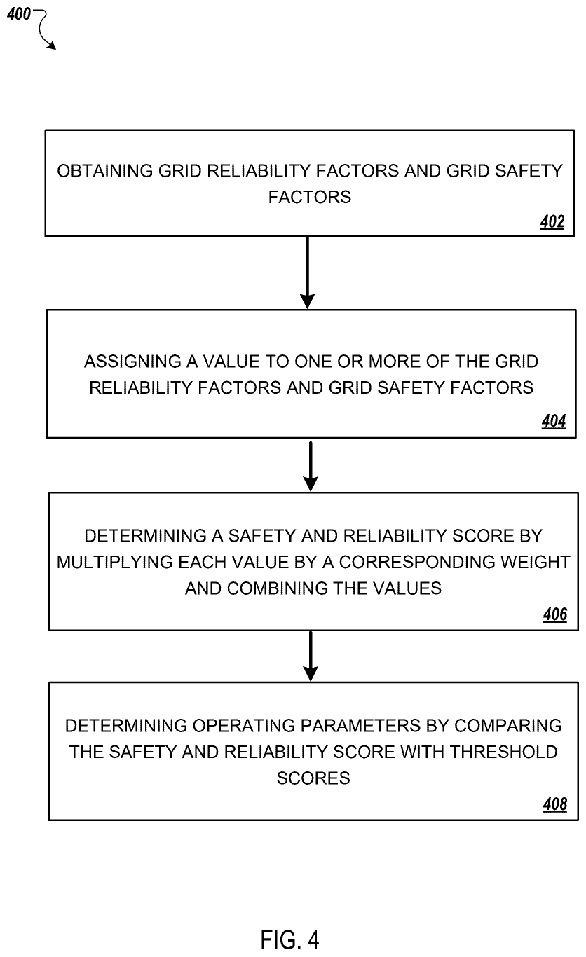

For example, the time of day may affect safety and reliability considerations. For example, during the daytime it is likely to be drier and hotter. A fire may be more likely to occur during the day, so a higher weight toward safety when balancing grid reliability and grid safety factors may be appropriate, as described below with reference to FIG. 4. As another example, it is likely that electricity is more important at night time, for example, when more customers rely on electricity. Thus a higher weight toward reliability when balancing grid reliability and grid safety factors may be appropriate.

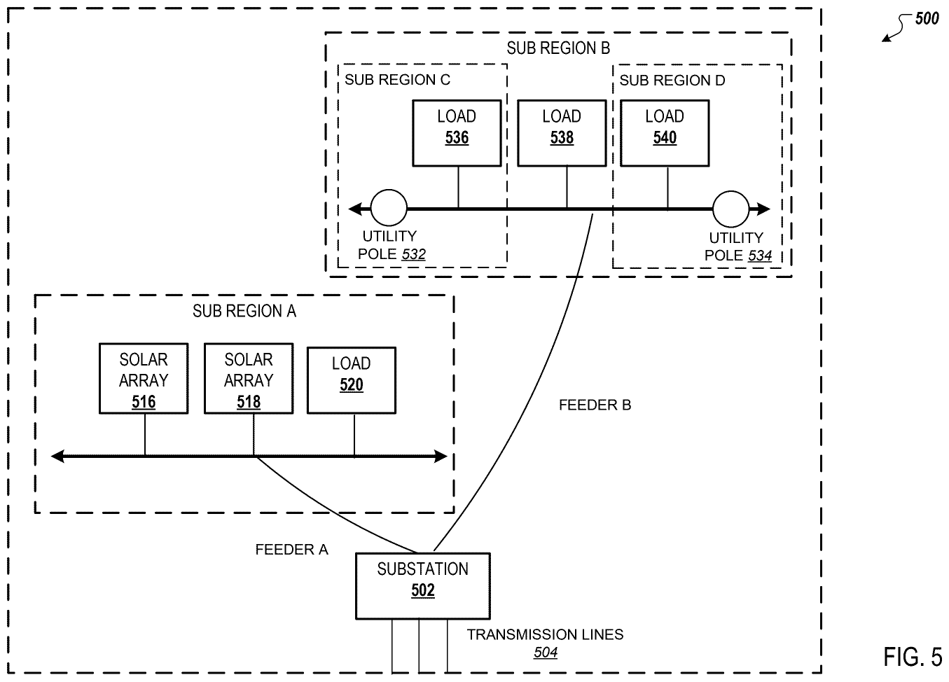

Weather conditions that are conducive to fires starting and burning may indicate that a higher weight toward safety when balancing grid reliability and grid safety factors may be appropriate, as described below with reference to FIG. 4. For example, higher temperatures and lower humidity may indicate a higher fire risk. As another example, weather conditions such as a nearby fire or lightning conditions may also indicate a higher fire risk. As another example, weather conditions such as rain, snow, or cold temperatures may indicate that a higher weight toward reliability when balancing grid reliability and grid safety factors may be appropriate. In some implementations, weather conditions can include local environmental conditions, such as data about humidity or lightning strikes, as described with reference to sub region C of FIG. 5. In some implementations, weather conditions can include environmental conditions over a larger area, such as precipitation, as described with reference to region 500 of FIG. 5.

Sensor data 210, such as images of vegetation, may indicate that there are tall trees near a utility pole that the monitor 209 is located on. Vegetation that can act as fuel for fires may indicate that a higher weight toward safety when balancing grid reliability and grid safety factors may be appropriate, as described below with reference to FIG. 4.

Local environmental condition data 214 may indicate that there is a low humidity at monitor 209, or that lightning strikes have been detected in the recent past at monitor 209. Such local environmental conditions can indicate conditions conducive to fires. Thus a higher weight toward safety when balancing grid reliability and grid safety factors may be appropriate, as described below with reference to FIG. 4.

Data indicative of a disturbance or fault such as fault data 218 may affect safety and reliability considerations. For example, depending on the timing or type of fault, the occurrence of a fault may indicate that a higher weight toward reliability when balancing grid reliability when balancing grid reliability and grid safety factors may be appropriate, as described below with reference to FIG. 4.

Load data 212 such as a higher load usage percentage may indicate that a large proportion of users are using electricity. Thus a higher weight towards reliability when balancing grid reliability and grid safety factors may be appropriate, as described below with reference to FIG. 4.

In implementations where the grid protection server 260 includes a grid model 232, the grid protection server 260 can obtain additional grid reliability factors and grid safety factors. For example, the grid model 232 can include a model of the electrical grid and include locations such as service centers. The grid protection server 260 may receive geographic location data 216 and/or identifier data in the electrical grid data 250, and use the grid model 232 to determine an case of sending a service team from a service center to the geographic location to address a potential fault in the region of electrical grid data 250. For example, a higher case of sending a service team to address a potential fault can indicate that a higher weight toward reliability when balancing grid reliability and grid safety factors may be appropriate, as described below in FIG. 4.

As another example, the grid protection server 260 can use the grid model 232 to determine how rerouting can occur in the grid to restore service to address a potential fault or disturbance in the region of electrical grid data 250. For example, if there are multiple ways to reroute to address a potential fault or disturbance, a higher weight toward reliability when balancing grid reliability and grid safety factors may be appropriate, as described below in FIG. 4.

As another example, the grid model 232 may include information about types of electricity sources and where they are located in the electrical grid. For example, the electricity sources may be inverter-based resources such as solar energy, DC wind generators, and power storage (e.g., batteries). The grid protection server 260 can determine a proportion of inverter-based resources in the region of electrical grid data 250. For example, the grid protection server 260 can receive geographic location data from inverters in the region of electrical grid data 250. The grid protection server 260 can then access the grid model 232 to identify inverter-based resources and non-inverter-based resources in the electrical grid. The grid protection server 260 can determine if the proportion of inverter-based resources in the region of electrical grid data 250 is above a threshold proportion, for example, compared to the proportion of inverter-based resources in other regions of the electrical grid. For example, as shown in FIG. 5, the proportion of inverter-based resources in sub region A is higher than the proportion of inverter-based resources in sub region B. For example, a region having a higher proportion of inverter-based resources can affect operating parameters of components in the region, as described below with reference to FIG. 4. As another example, the grid protection server 260 can use the grid model 232 to determine a load criticality factor. For example, the grid model 232 may include information about the type and number of customers and loads. For example, the grid protection server 260 can use the grid model 232 to determine whether the region of electrical grid data 250 includes customers such as homes, hospitals or buildings with sensitive electronic equipment. For example, a region with a larger number of critical loads, or a region with loads of higher criticality, can have a higher load criticality factor than a region with a fewer number of critical loads, or a region with loads of lower criticality. Loads of higher criticality can include, for example, medical facilities such as hospitals and elderly care facilities, emergency facilities such as fire departments and police departments, and buildings with sensitive electronic equipment. Loads of lower criticality, for example, can include residential loads such as homes, or commercial loads such as retail businesses. A higher load criticality factor can indicate that a higher weight toward reliability when balancing grid reliability and grid safety factors may be appropriate, as described below with reference to FIG. 4.

In implementations where the grid protection server 260 includes a historical grid database 234, the grid protection server 260 can use the historical grid database 234 to obtain additional grid reliability factors and grid safety factors. For example, the historical grid database 234 can store load data collected over periods of times, e.g., months and years. For example, the historical grid database 234 can store load data in tables. The historical grid database 234 can be used to monitor trends in electricity usage in the region of the electrical grid data 250, for example. Thus the grid protection server 260 can use the historical grid database 234 to estimate a load usage percentage at a given time of day. A higher historical load usage percentage at night, for example, can indicate that a higher weight toward reliability when balancing grid reliability and grid safety factors at night may be appropriate, as described below with reference to FIG. 4.

As another example, the grid protection server 260 can use electrical grid data 250, the grid model 232, and the historical grid database 234 to determine potential ways to reroute to address potential faults. For example, with reference to FIG. 5, the grid protection server 260 can determine from electrical grid data 250 and historical grid database 234 that the two solar arrays 516 and 518 in sub region A are sufficient to power sub region A during a day-time power outage in full sun. The grid protection server 260 can determine using the grid model 232 that feeder A can be shut down or islanded temporarily to preferentially supply limited power resources to feeder B if needed (e.g., if sub region B has a higher load criticality factor and/or fewer inverter-based resources).

The reliability and safety factor analysis engine 236 can also receive environmental conditions 238. The environmental conditions 238 can describe environmental conditions in a region larger than the local environmental condition data 214 measured by the monitor 209. For example, local environmental condition data 214 may describe the humidity at monitor 209, while environmental conditions 238 can describe a prediction or current observation of conditions such as precipitation or a fire in an area close to the region of electrical grid data 250. For example, environmental conditions such as snow or rain can indicate that a higher weight toward reliability when balancing grid reliability and grid safety factors may be appropriate, as described below with reference to FIG. 4. As another example, environmental conditions such as a lightning storm can indicate that a higher weight toward safety may be appropriate. Environmental conditions such as a fire can indicate that a higher weight toward safety may be appropriate.

The grid protection server 260 can update the grid model 232. For example, upon receiving electrical grid data 250 that includes monitor data from a geographic location or monitor with an identifier that is not in the current grid model 232, the grid protection server 260 can update the grid model 232. For example, upon receiving electrical grid data 250, the grid protection server 260 can determine the geographic locations or identifiers corresponding to the monitor data in electrical grid data 250. For each monitor, the grid protection server 260 can determine whether the current grid model 232 includes a monitor at the geographic location or with the identifier. If the current grid model 232 does not include the monitor, the grid protection server 260 can update the grid model 232 to include the monitor.

The grid protection server 260 can update the historical grid database 234. For example, the grid protection server 260 can update the load data in historical grid database 234 with new load data received in electrical grid data 250. For example, the grid protection server 260 can add new entries to the load data tables in historical grid database 234.

The reliability and safety factor analysis engine 236 performs an analysis that balances the grid reliability factors and grid safety factors and generates aggregated operating parameters. The analysis will be described in further detail with respect to FIG. 4.

The grid protection server 260 outputs the aggregated operating parameters 245 generated by the reliability and safety factor analysis engine 236 to the controller 201. The aggregated operating parameters 245 can include, for example, a setpoint or a mode of operation for one or more electrical protection devices. The aggregated operating parameters 245 can also include an identifier that identifies which electrical protection device each set of operating parameters 245 corresponds to.

The controller 201 receives aggregated operating parameters 245 and sends operating parameters 246 to the corresponding electrical protection device 270. The electrical protection device 270 can change its behavior according to the operating parameters 246.

The electrical protection device 270 can be an inverter 272 or a recloser 274 that is part of a protective scheme, for example. The operating parameters 245 can specify a setpoint or set a mode of operation for a protective scheme, such as how many times to attempt a reclosing, a fault current, or activating or deactivating a recloser in the protective scheme. The operating parameters 245 can specify a mode of operation for an inverter, such as activating or deactivating the inverter.

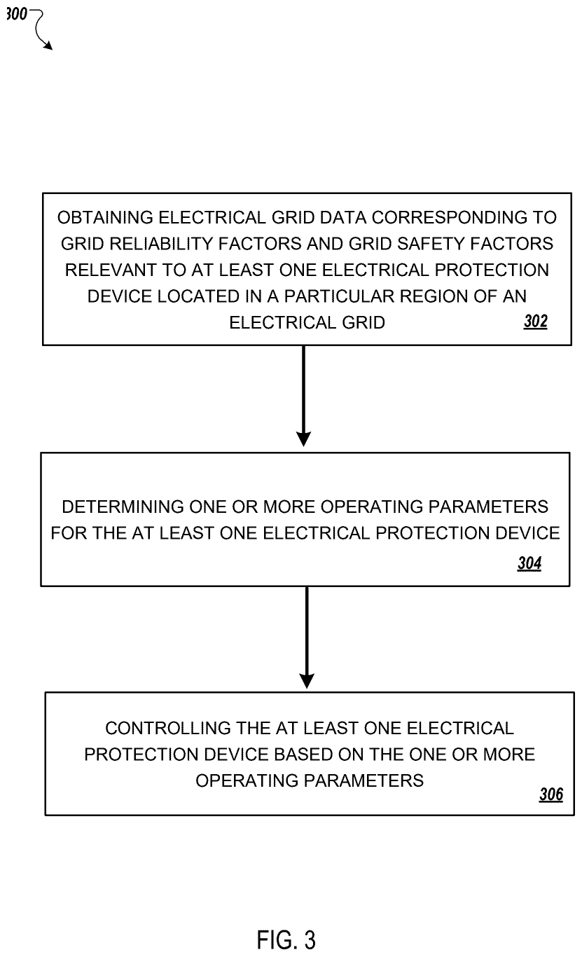

FIG. 3 is a flowchart of an example process 300 for dynamically protecting an electrical grid. The process 300 can be performed by any appropriate system, such as the system 100 of FIG. 1.

The system obtains electrical grid data corresponding to grid reliability factors and grid safety factors relevant to at least one electrical protection device located in a particular region of an electrical grid (302). For example, the grid safety factors can include a time of day, weather within the particular region or sub region, vegetation within the particular region or sub region, humidity within the particular region or sub region, or data indicative of a fault. The grid reliability factors can include, for example, a time of day, data indicative of a fault, a load usage percentage, a type of electrical source, a number of customers, a type of customer, a geographic location, or a load criticality factor.

In some implementations, the particular region includes one or more sub regions. Each sub region can be specific to one or more of the grid reliability factors or grid safety factors. For example, a sub region for an environmental condition is smaller than a sub region for a load criticality factor. An example of regions and sub regions is discussed below with reference to FIG. 5.

The system determines one or more operating parameters for the at least one electrical protection device (304). The system can determine the one or more operating parameters based on an analysis of the grid reliability factors and the grid safety factors. The analysis balances the grid reliability factors against the grid safety factors for the particular region.

For example, the electrical protection device can be a recloser in a protective scheme or an inverter. If the electrical protection device is a recloser within the particular region, the system can obtain a fault setpoint for the recloser. The system can determine that a proportion of inverter-based resources within the particular region is greater than a threshold. In response, the system can adjust the fault setpoint in accordance with the proportion of inverter-based resources. For example, the system can lower the fault setpoint.

In some implementations, the system can receive data indicative of a fault in the electrical grid. The system can determine a fault type based on the data. Determining one or more operating parameters can include dynamically adjusting the operating parameters based on the fault type. For example, the system can determine that the operating parameters should prioritize safety. If a fault is a permanent type of fault, the operating parameters can include a mode of operation that indicates a deactivated mode for a recloser in a protective scheme. The system can also determine that the operating parameters should prioritize reliability. If a fault is a temporary type of fault, the operating parameters can include a mode of operation that indicates an activated mode for the recloser.

As another example, the system can determine a time of fault based on the data. For example, the system can receive a timestamp of a potential fault. Determining one or more operating parameters can include dynamically adjusting the operating parameters based on the time of fault. For example, the system can determine the loading in the electrical grid in a window of time after the time of fault, and thus determine any downstream impacts of the fault. For example, the loading may indicate that the fault was cleared, or that the fault resulted in a disconnection. For example, the system can determine that the operating parameters should prioritize reliability. If the loading indicates that the fault resulted in a disconnection, the operating parameters can include a mode of operation that indicates an activated mode for a recloser in a protective scheme, for example.

The system controls the at least one electrical protection device based on the one or more operating parameters (306). For example, controlling an electrical protection device can include adjusting the operating parameters or changing the mode of operation of the electrical protection device.

For example, the at least one electrical protection device can be a recloser operating at a first setpoint in a protective scheme. The one or more operating parameters can include a second setpoint. Controlling the recloser based on the one or more operating parameters can include sending instructions to the recloser to change the first setpoint to the second setpoint. For example, the first setpoint can be a voltage or current fault trip setpoint. The system can determine, for example, that the operating parameters should prioritize reliability. Thus the operating parameters can include a second setpoint that is a lower voltage or current fault trip setpoint. The protective scheme will thus attempt reclosing more often, increasing reliability of the electrical grid.

If the system determines that the operating parameters should prioritize safety, the operating parameters can include a second setpoint that is a higher voltage or current fault trip setpoint. The protective scheme will thus attempt reclosing less often, decreasing the risk for fires and prioritizing safety.

As another example, the first setpoint can be a maximum number of attempted reclosings. The system can determine, for example, that the operating parameters should prioritize reliability. Thus the operating parameters can include a second setpoint that is a larger maximum number of attempted reclosings. The protective scheme will thus attempt more reclosings, increasing reliability of the electrical grid.

If the system determines that the operating parameters should prioritize safety, the operating parameters can include a second setpoint that is a lower maximum number of attempted reclosings. The protective scheme will thus attempt fewer reclosings, decreasing the risk for fires and prioritizing safety.

As another example, the first setpoint can be a frequency of reclosings. The system can determine, for example, that the operating parameters should prioritize reliability. Thus the operating parameters can include a second setpoint that is a higher frequency of reclosings. The protective scheme will thus attempt reclosings more frequently, increasing reliability of the electrical grid.

If the system determines that the operating parameters should prioritize safety, the operating parameters can include a second setpoint that is a lower frequency of attempted reclosings. The protective scheme will thus attempt reclosings less frequently, decreasing the risk for fires and prioritizing safety.

In some implementations, the value of setpoints that prioritize safety and reliability may be pre-defined. In some implementations, there may be multiple values for setpoints that define different levels of safety and reliability.

As another example, the at least one electrical protection device can be a recloser operating at a first mode of operation in a protective scheme. The one or more operating parameters can include a second mode of operation. Controlling the recloser based on the one or more operating parameters can include sending instructions to the recloser to change the first mode of operation to the second mode of operation. For example, the first mode of operation can be a deactivated mode. The system can determine, for example, that the operating parameters should prioritize reliability. Thus the second mode of operation can be an activated mode. The protective scheme will thus use the recloser to perform reclosings, increasing reliability of the electrical grid.

As another example, the first mode of operation can be an activated mode. The system can determine, for example, that the operating parameters should prioritize safety. Thus the second mode of operation can be a deactivated mode. The protective scheme will thus not use the recloser to perform reclosings, decreasing the risk for fires.

As another example, the first mode of operation can be a high reliability mode, with setpoints that prioritize reliability such as a low fault trip setpoint, large maximum number of attempted reclosings, or high frequency of reclosings. The system can determine, for example, that the operating parameters should prioritize safety. Thus the second mode of operation can be a high protection mode, with setpoints that prioritize safety such as a high fault trip setpoint, low maximum number of attempted reclosings, or low frequency of reclosings.

The first mode of operation can also be a high protection mode. The system can determine, for example, that the operating parameters should prioritize reliability. Thus the second mode of operation can be a high reliability mode with setpoints that prioritize reliability such as a low fault trip setpoint, large maximum number of attempted reclosings, or high frequency of reclosings.

As another example, the at least one electrical protection device can be an inverter operating at a first mode of operation. The one or more operating parameters can include a second mode of operation. Controlling the inverter based on the one or more operating parameters can include sending instructions to the inverter to change the first mode of operation to the second mode of operation. For example, the first mode of operation can be a deactivated mode. The system can determine, for example, that the operating parameters should prioritize reliability. Thus the second mode of operation can be a low-power or standby mode that keeps the inverter activated and allows the inverter to absorb excess current from a fault.

As another example, the first mode of operation can be an activated mode. If the system determines that the operating parameters do not prioritize reliability, the system can determine operating parameters that deactivate the inverter.

In some implementations, the system can send instructions to an electrical protection device to change the first mode of operation to the second mode of operation upon detection of a nearby fault. For example, if the system detects a fault, the system can send instructions to electrical protection devices located near the detected fault to change from the high protection mode to the high reliability mode. If the system detects that the fault has not been cleared, the system can send instructions to other electrical protection devices located farther away to change to the high reliability mode as well.

FIG. 4 is a flowchart of an example process 400 for determining operating parameters for components in the electrical grid using grid reliability factors and grid safety factors. The process 400 can be performed by any appropriate system, e.g., the reliability and safety factor analysis engine 236 of FIG. 2.

The system obtains grid reliability factors and grid safety factors (402). For example, the system can receive electrical grid data and environmental conditions data and apply the data to grid reliability factors and grid safety factors. For example, the grid safety factors can include a time of day, weather within the particular region or sub region, vegetation within the particular region or sub region, humidity within the particular region or sub region, or data indicative of a fault. The grid reliability factors can include, for example, a time of day, data indicative of a fault, a load usage percentage, a type of electrical source, a number of customers, a type of customer, a geographic location, or a load criticality factor. Grid reliability factors can also include an case of sending a service team to address a potential fault and how rerouting can occur in the grid to restore service to address a potential fault.

The system can assign a value to one or more of the grid reliability factors and grid safety factors (404). For example, a type of customer may be commercial or residential. The system can assign a numeric value to the type of customer factor based on a pre-defined set of values that correspond to the type of customer. As another example, the weather conditions may be described as “rain,” “snow,” or “thunderstorm.” The system can assign a numeric value to the weather conditions using a pre-defined set of values that correspond to the type of customer. The system may also assign a value to a factor using pre-defined ranges of values. For example, the system can assign a value of “1” to the number of customers factor if the number of customers is less than 100, a value of “2” if the number of customers factor is less than 1,000, etc.

In some implementations, the system can scale the values of one or more of the grid reliability factors and grid safety factors. For example, factors such as humidity or temperature may vary widely. The system may use a multiplier to scale up or scale down numeric values.

The system determines a safety and reliability score by multiplying each value by a corresponding weight and combining the values into the reliability score (406). The individual values can be combined by, e.g., addition, an adaptive learning system (e.g., machine learning model). For example, the corresponding weight for a value can represent a relative importance of the value. For example, a weather condition such as a nearby fire may be more important in grid protection than a type of electrical source, so the corresponding weight for the weather condition may be higher than the corresponding weight for the type of electrical source.

In some implementations, the corresponding weights can be positive or negative. For example, for a factor that would weigh more heavily toward prioritizing safety, such as a nearby fire, the corresponding weight can be positive. For a factor that would weigh more heavily toward prioritizing reliability, such as a load criticality factor, the corresponding weight can be negative.

In some implementations, the corresponding weights can be pre-defined. In some implementations, the corresponding weights can be updated. For example, an environmental factor may be less important in the winter when the risk of fire is not as high, so the corresponding weights can be updated to reflect a change in season, for example.

The system determines operating parameters by comparing the safety and reliability score with threshold scores (408). For example, if the safety and reliability score is less than a certain threshold score, the system may determine operating parameters that prioritize reliability. For example, the threshold score can be zero (e.g., if the safety and reliability score is greater than or equal to zero, the system can determine operating parameters that prioritize safety, and if not, the system can determine operating parameters that prioritize reliability). As an example, although reclosings can address faults and restore power to improve reliability of the electrical grid, each reclosing carries the risk of creating an arc that can cause fires that threaten safety. For example, the system can increase the maximum number of attempted reclosings by a recloser. If the safety and reliability score is greater than or equal to a certain threshold score, the system may determine operating parameters that prioritize safety. For example, the system can decrease the maximum number of attempted reclosings by a recloser.

As another example, the system can determine that a fault resulted in a disconnection, weighing more heavily toward prioritizing reliability to restore service in the grid. The system can also determine that weather conditions are dry and hot, weighing more heavily toward prioritizing safety. By balancing potentially conflicting factors, the system can dynamically adjust the behavior of components to prioritize safety or reliability.

The system can have more than one threshold score. For example, if the safety and reliability score is less than a first threshold score, the system may determine operating parameters that heavily prioritize reliability. The system can set the maximum number of attempted reclosings to 10, for example. If the safety and reliability score is greater than or equal to the first threshold score and less than a second threshold score, the system may determine operating parameters that prioritize reliability. The system can set the maximum number of attempted reclosings to 2, for example. If the safety and reliability score is greater than or equal to the second threshold score, the system may determine operating parameters that prioritize safety. The system can set the maximum number of attempted reclosings to 0, for example.

In some implementations, the threshold scores can be pre-defined. In some implementations, the threshold scores can be updated. For example, in hotter and drier conditions such as during the summer, where fires are more likely to start, the threshold scores may be lower than the threshold scores in colder and wetter conditions such as during the winter. The system can be more likely to determine operating parameters that prioritize safety during the summer. Thus the threshold scores can be updated depending on the time of year, for example. The threshold scores can also be updated depending on the time of day. For example, the threshold scores may be higher at night than during the day, when electricity usage may be higher and more necessary. The system can be more likely to determine operating parameters that prioritize reliability at night.

As another example, the system can determine operating parameters that activate the recloser when the safety and reliability score prioritizes reliability, and that deactivate the recloser when the safety and reliability score prioritizes safety.

The system can also determine operating parameters using one factor. For example, inverter-based resources cannot provide the fault current that reclosers require for operation that a typical generator could provide. Thus, the system can increase the fault current of a recloser when the proportion of inverter-based resources in a region or sub region is lower than a threshold proportion of inverter-based resources, or decrease the fault current when the proportion of inverter-based resources is higher than a threshold proportion of inverter-based resources.

The system can determine operating parameters that activate an inverter or keep the inverter activated when the safety and reliability score prioritizes reliability. For example, an inverter typically deactivates at night while solar power is not being generated. Thus, if the operating parameters keep the inverter activated at night, for example in a standby mode, the inverter can absorb excess current from a fault and help keep the electrical grid operational. When the safety and reliability score does not prioritize reliability, the system can determine operating parameters that deactivate the inverter or let the inverter deactivate at night as it would typically do.

FIG. 5 is a diagram of an example region 500 with sub regions corresponding to grid reliability factors and grid safety factors. A system such as system 100 balances grid reliability factors and grid safety factors that correspond to different regions or sub regions. The region 500 includes a sub region A, sub region B, sub region C, and sub region D.

The region 500 encloses part of the electrical grid that includes substation 502. The substation 502 is connected to transmission lines 504 that transport electrical power to the substation 502. The substation 502 transports electrical power to the electrical power line in sub region A through feeder A, and to the electrical power line running through utility poles 532 and 534 in sub region B through feeder B.

Sub region A encloses solar array 516, solar array 518, and load 520. Sub region B encloses utility pole 532, utility pole 534, load 536, load 538, and load 540. Sub region B also encloses sub region C and sub region D. Sub region C encloses utility pole 532 and load 536, and sub region D encloses utility pole 534 and load 540.

Each region or sub region can be specific to one or more grid reliability factors or grid safety factors. For example, environmental conditions such as precipitation or nearby fires can be measured over the entire region 500. Environmental conditions can also be measured over sub region C. For example, the humidity or lightning detection for sub region C can be measured by a monitor at utility pole 532.

Load data can be measured over different sub regions. For example, a load usage percentage can be measured over region 500 and include loads 520, 536, 538, and 540. A load usage percentage can also be measured over sub region A and include load 520. A load usage percentage can also be measured over sub region B and include loads 536, 538, and 540. Other types of load data such as a load criticality factor can also be measured over different sub regions. For example, load 536 may be a critical type of load such as a hospital, while loads 540 and 520 are residential properties. The load criticality factor for sub region B may be higher than the load criticality factor for sub region A because sub region B includes more loads, and one of the loads is a hospital.

The types of vegetation and their condition, such as whether trees have leaves or no leaves, can vary widely across the region 500. Thus, the types of vegetation and their condition can be measured over smaller sub regions than region 500, for example, in sub region C and sub region D.

The types of electrical sources can also be measured over different sub regions. For example, a proportion of inverter-based resources can be measured over sub region A and sub region B. Sub region A encloses solar arrays 516 and 518 and load 520, while sub region B includes loads 536, 538, and 540. Thus, sub region A has a higher proportion of inverter-based resources than sub region B.

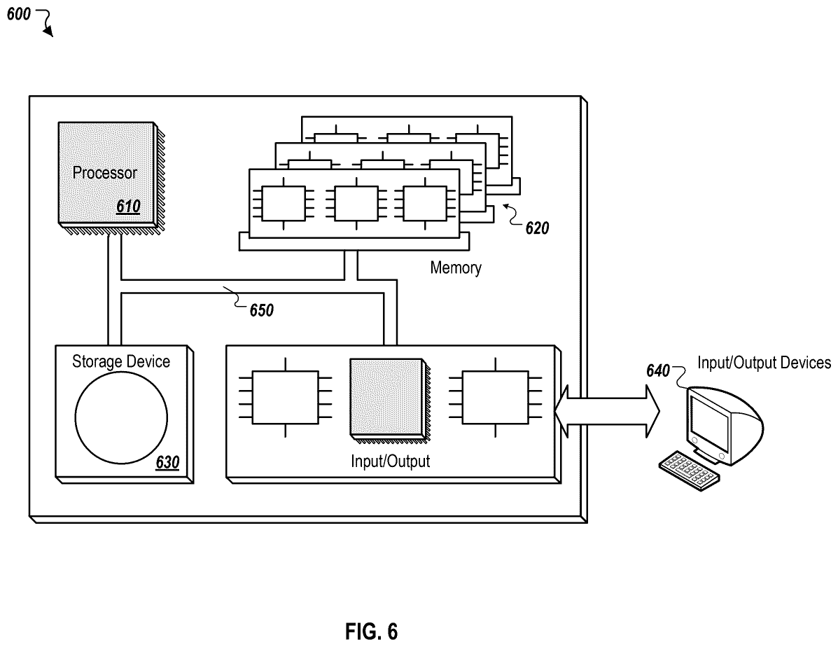

FIG. 6 is a schematic diagram of a computer system 600. The system 600 can be used to carry out the operations described in association with any of the computer-implemented methods described previously, according to some implementations. In some implementations, computing systems and devices and the functional operations described in this specification can be implemented in digital electronic circuitry, in tangibly-embodied computer software or firmware, in computer hardware, including the structures disclosed in this specification (e.g., system 600) and their structural equivalents, or in combinations of one or more of them. The system 600 is intended to include various forms of digital computers, such as laptops, desktops, workstations, personal digital assistants, servers, blade servers, mainframes, and other appropriate computers, including vehicles installed on base units or pod units of modular vehicles. The system 600 can also include mobile devices, such as personal digital assistants, cellular telephones, smartphones, and other similar computing devices. Additionally, the system can include portable storage media, such as, Universal Serial Bus (USB) flash drives. For example, the USB flash drives may store operating systems and other applications. The USB flash drives can include input/output components, such as a wireless transducer or USB connector that may be inserted into a USB port of another computing device.

The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. The processor may be designed using any of a number of architectures. For example, the processor 610 may be a CISC (Complex Instruction Set Computers) processor, a RISC (Reduced Instruction Set Computer) processor, or a MISC (Minimal Instruction Set Computer) processor.

In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

The described systems, methods, and techniques may be implemented in digital electronic circuitry, computer hardware, firmware, software, or in combinations of these elements. Apparatus implementing these techniques may include appropriate input and output devices, a computer processor, and a computer program product tangibly embodied in a machine-readable storage device for execution by a programmable processor. A process implementing these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially-designed ASICs (application-specific integrated circuits).

It will be understood that various modifications may be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

Functional operations described in this specification may be implemented in digital electronic circuitry, or in computer software, firmware, or hardware, including the structures disclosed in this specification and their structural equivalents, or in combinations of one or more of them. The techniques disclosed may be implemented as one or more computer program products, i.e., one or more modules of computer program instructions encoded on a computer-readable medium for execution by, or to control the operation of, data processing apparatus. The computer readable-medium may be a machine-readable storage device, a machine-readable storage substrate, a memory device, a composition of matter affecting a machine-readable propagated signal, or a combination of one or more of them. The computer-readable medium may be a non-transitory computer-readable medium. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, the techniques disclosed may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Implementations may include a computing system that includes a back end component, e.g., as a data server, or that includes a middleware component, e.g., an application server, or that includes a front end component, e.g., a client computer having a graphical user interface or a Web browser through which a user may interact with an implementation of the techniques disclosed, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

Thus, particular implementations have been described. Other implementations are within the scope of the following claims. For example. the actions recited in the claims may be performed in a different order and still achieve desirable results.

What is claimed is:

1. A computer-implemented electrical grid dynamic protection method comprising:
obtaining electrical grid data corresponding to grid reliability factors and grid safety factors relevant to at least one electrical protection device located in a particular region of an electrical grid;
determining, based on an analysis of the grid reliability factors and the grid safety factors, one or more operating parameters for the at least one electrical protection device, wherein the analysis balances the grid reliability factors against the grid safety factors for the particular region; and
controlling the at least one electrical protection device based on the one or more operating parameters.

2. The method of claim 1, wherein the particular region comprises one or more sub regions, each sub region being specific to one or more of the grid reliability factors or grid safety factors.

3. The method of claim 1, wherein a sub region for an environmental condition is smaller than a sub region for a load criticality factor.

4. The method of claim 1, wherein the grid safety factors comprise at least one of: a time of day, weather within the particular region or sub region, vegetation within the particular region or sub region, humidity within the particular region or sub region, or data indicative of a fault.

5. The method of claim 1, wherein the grid reliability factors comprise at least one of: a time of day, data indicative of a fault, a load usage percentage, a type of electrical source, a number of customers, a type of customer, a geographic location, or a load criticality factor.

6. The method of claim 1, wherein at least one electrical protection device is a recloser in a protective scheme operating at a first setpoint,
wherein the one or more operating parameters comprise a second setpoint, and
wherein controlling the recloser based on the one or more operating parameters comprises sending instructions to the recloser to change the first setpoint to the second setpoint.

7. The method of claim 1, wherein determining the one or more operating parameters comprises:
obtaining, for a recloser within the particular region, a fault setpoint;
determining that a proportion of inverter-based resources within the particular region is greater than a threshold; and
in response, adjusting the fault setpoint in accordance with the proportion of inverter-based resources.

8. The method of claim 1, wherein at least one electrical protection device is a recloser in a protective scheme operating at a first mode of operation, and wherein the one or more operating parameters comprise a second mode of operation, and wherein controlling the recloser based on the one or more operating parameters comprises sending instructions to the recloser to change the first mode of operation to the second mode of operation.

9. The method of claim 1, wherein at least one electrical protection device is an inverter operating at a first mode of operation, and wherein the one or more operating parameters comprise a second mode of operation, and wherein controlling the inverter based on the one or more operating parameters comprises sending instructions to the inverter to change the first mode of operation to the second mode of operation.

10. The method of claim 1, wherein the method further comprises:
receiving data indicative of a fault in the electrical grid; and
determining a fault type based on the data, and
wherein determining one or more operating parameters comprises dynamically adjusting the operating parameters based on the fault type.

11. The method of claim 1, wherein the method further comprises:
receiving data indicative of a fault in the electrical grid; and
determining a time of fault based on the data, and
wherein determining one or more operating parameters comprises dynamically adjusting the operating parameters based on the time of fault.

12. The method of claim 1, wherein determining one or more operating parameters for the at least one electrical protection device comprises:
obtaining grid reliability factors and grid safety factors;
assigning a value to one or more of the grid reliability factors and grid safety factors;
determining a safety and reliability score by multiplying each value by a corresponding weight and combining the values; and
determining operating parameters by comparing the safety and reliability score with threshold scores.

13. A system comprising:
at least one processor; and a data store coupled to the at least one processor having instructions stored thereon which, when executed by the at least one processor, causes the at least one processor to perform operations comprising:
obtaining electrical grid data corresponding to grid reliability factors and grid safety factors relevant to at least one electrical protection device located in a particular region of an electrical grid;
determining, based on an analysis of the grid reliability factors and the grid safety factors, one or more operating parameters for the at least one electrical protection device, wherein the analysis balances the grid reliability factors against the grid safety factors for the particular region; and
controlling the at least one electrical protection device based on the one or more operating parameters.

14. The system of claim 13, wherein the particular region comprises one or more sub regions, each sub region being specific to one or more of the grid reliability factors or grid safety factors.

15. The system of claim 13, wherein a sub region for an environmental condition is smaller than a sub region for a load criticality factor.

16. The system of claim 13, wherein the grid safety factors comprise at least one of: a time of day, weather within the particular region or sub region, vegetation within the particular region or sub region, humidity within the particular region or sub region, or data indicative of a fault.

17. The system of claim 13, wherein the grid reliability factors comprise at least one of: a time of day, data indicative of a fault, a load usage percentage, a type of electrical source, a number of customers, a type of customer, a geographic location, or a load criticality factor.

18. The system of claim 13, wherein at least one electrical protection device is a recloser in a protective scheme operating at a first setpoint,
wherein the one or more operating parameters comprise a second setpoint, and
wherein controlling the recloser based on the one or more operating parameters comprises sending instructions to the recloser to change the first setpoint to the second setpoint.

19. The system of claim 13, wherein determining the one or more operating parameters comprises:
obtaining, for a recloser within the particular region, a fault setpoint;
determining that a proportion of inverter-based resources within the particular region is greater than a threshold; and
in response, adjusting the fault setpoint in accordance with the proportion of inverter-based resources.

20. A non-transitory computer readable storage media storing instructions that, when executed by at least one processor, cause the at least one processor to perform operations comprising:
obtaining electrical grid data corresponding to grid reliability factors and grid safety factors relevant to at least one electrical protection device located in a particular region of an electrical grid;
determining, based on an analysis of the grid reliability factors and the grid safety factors, one or more operating parameters for the at least one electrical protection device, wherein the analysis balances the grid reliability factors against the grid safety factors for the particular region; and
controlling the at least one electrical protection device based on the one or more operating parameters.
